(19) United States
(12) Patent Application Publication
(10) Pub. No.: US 2013/0325293 A1
(43) Pub. Date: Dec. 5, 2013

(54) System And Method For Controlling Engine Torque Load

(71) Applicant: Evan Earl Jacobson, Edwards, IL (US)

(72) Inventor: Evan Earl Jacobson, Edwards, IL (US)

(73) Assignee: CATERPILLAR INC., Peoria, IL (US)

(21) Appl. No.: 13/484,855

(22) Filed: May 31, 2012

(51) Int. Cl. F02D 28/00

(52) U.S. Cl. 701/103

(57) ABSTRACT

A machine includes at least one torque consuming device drivingly coupled with an internal combustion engine. An electronic controller is in communication with the engine and the torque consuming device, and is configured to receive a load request and determine a current operating state of the engine. The electronic controller simulates transition of the engine from the current operating state to a requested operating state according to a plurality of different load application pathways. An engine response characteristic for each of the different load application pathways is determined, and the electronic controller selects one of the different load application pathways based on the engine response characteristic. The engine is then transitioned from the current operating state to the requested operating state according to the selected load application pathway.

### TECHNICAL FIELD

The present disclosure relates generally to a system and method for controlling engine torque load and, more particularly, to selecting a load application pathway for transitioning the engine from a current operating state to a requested operating state based on engine response characteristics predicted during onboard simulations.

### BACKGROUND

Many machines, including off-highway machines such as, for example, loaders, graders, excavators, and dozers, utilize numerous devices and/or systems that receive power from a main power source, such as an internal combustion engine. For example, many machines commonly include engine driven pumps that provide high pressure fluid to operate an implement system of the machine. In particular, a loader may use high pressure fluid to move actuators associated with a bucket of the loader. In addition, many machines utilize continuously variable transmissions that use engine driven pumps for providing high pressure fluid to drive ground engaging elements, such as wheels, of the machine. As the power requested from these engine powered systems increases, operation of the engine must be adapted to accommodate these loads. For example, air and/or fuel provided to the engine may be increased in order to increase the power, or work, produced by the engine to meet the new power demands.

Some strategies have been provided for managing operation of the engine to meet the changing power demands. For example, U.S. Patent Application Publication No. 2003/216847 to Bellinger teaches a strategy for controlling an internal combustion engine in a more fuel efficient manner. In particular, Bellinger teaches a strategy for limiting engine operation to a preferred, or more fuel efficient, operating range, based on data stored in memory that defines regions of desirable and undesirable operation. Although the strategy in Bellinger may improve fuel economy under certain operating conditions, it should be appreciated that there exists a continuing desire to improve or optimize engine performance.

The present disclosure is directed to one or more of the problems or issues set forth above.

### SUMMARY OF THE DISCLOSURE

In one aspect, a machine includes at least one torque consuming device drivingly coupled with an internal combustion engine, and an electronic controller in communication with the internal combustion engine and the torque consuming device. The electronic controller is configured to receive a load request, and determine a current operating state of the internal combustion engine. The electronic controller simulates transition of the internal combustion engine from the current operating state to a requested operating state according to a plurality of different load application pathways. An engine response characteristic for each of the different load application pathways is determined, and the electronic controller selects one of the load application pathways based on the engine response characteristic. The internal combustion engine is then transitioned from the current operating state to the requested operating state according to the selected load application pathway.

In another aspect, a method of controlling engine torque load includes steps of generating a load request, and determining a current operating state of an internal combustion engine responsive to the load request. The method also includes simulating transition of the internal combustion engine from the current operating state to a requested operating state according to a plurality of different load application pathways using an onboard electronic controller of the machine. An engine response characteristic for each of the different load application pathways is determined using the onboard electronic controller, and one of the different load application pathways is selected based on the engine response characteristic. The internal combustion engine is then transitioned from the current operating state to the requested operating state according to the selected load application pathway.

In yet another aspect, a computer readable medium for use by an electronic controller for a machine having at least one torque consuming device drivingly coupled with an internal combustion engine includes executable instructions for performing a method of controlling engine torque load. The method includes receiving a load request signal, and receiving input signals from the internal combustion engine. A current operating state of the internal combustion engine is determined based on the input signals. The method also includes simulating transition of the internal combustion engine from the current operating state to a requested operating state according to a plurality of different load application pathways. An engine response characteristic for each of the different load application pathways is determined, and at least one of the different load application pathways is selected based on the engine response characteristic. At least one of an engine control signal and a torque consuming device control signal is generated corresponding to the selected load application pathway.

### BRIEF DESCRIPTION OF THE DRAWINGS

FIG. 1 is a side diagrammatic view of a machine, according to the present disclosure;

FIG. 2 is an exemplary control system schematic of the machine of FIG. 1 including torque producing devices and torque consuming devices, according to an exemplary embodiment of the present disclosure;

FIG. 3 is exemplary control system logic corresponding to an exemplary torque load control algorithm, according to one aspect of the present disclosure;

FIG. 4 is a logic flow chart of one embodiment of a method for controlling engine torque load, according to another aspect of the present disclosure;

FIG. 5 is an exemplary graph of load versus time illustrating a plurality of different load application pathways, according to another aspect of the present disclosure;

FIG. 6 is another exemplary chart of load versus time illustrating a plurality of different load application pathways, according to another aspect of the present disclosure; and

FIG. 7 is a table depicting engine response characteristics determined during simulations according to the different load application pathways of FIGS. 5 and 6, according to another aspect of the present disclosure.

### DETAILED DESCRIPTION

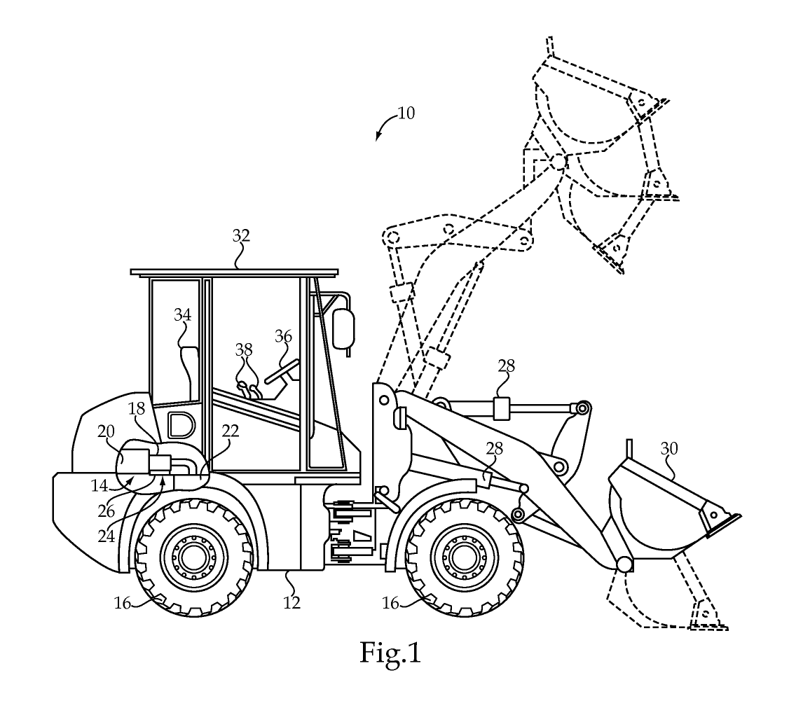

An exemplary embodiment of a machine 10 is shown generally in FIG. 1. The machine 10 may be a wheel loader, as shown, or any other off-highway or on-highway vehicle. Machine 10 may generally include a frame 12 having a drive system 14 supported thereon for driving ground engaging elements 16, such as wheels (shown) or tracks, of the machine 10. According to a specific example, the drive system 14 may be a hydrostatic drive system and may generally include at least one pump 18, such as a hydraulic pump, driven by a prime mover, such as a compression or spark-ignited internal combustion engine 20 or electric motor, of the machine 10. The pump 18 may be configured to drive at least one motor 22, such as one or more sets of hydraulic motors, which, in turn, power the ground engaging elements 16 of the machine 10. Each of the pump 18 and motor 22 may provide variable displacement, such that a fluid flow between the components of the hydrostatic drive system 14 may be adjusted while the machine 10 is running. As a result, direction, speed, and torque of the ground engaging elements 16, or wheels, may be continuously varied.

The machine 10 may also include an implement system 24 including at least one pump 26, such as a hydraulic pump, that is also driven by the engine 20. As should be appreciated, the pump 26 may generate pressurized fluid that is circulated along a fluid circuit, which includes control cylinders 28, to effect a desired movement of an implement 30, such as a bucket, of the machine 10. It should be appreciated that the implement system 24 may include additional components known in the art, such as, for example, fluid reservoirs, additional pumps, electronically actuated valves, filters, sensors, and the like for facilitating desired operation. As will be described below, an engine torque load control strategy provided herein is widely applicable to machines having a variety of engine loads and, thus, the drive system 14 and implement system 24 are provided for exemplary purposes only.

An operator control station 32 may also be supported on the frame 12 and may include various controls and devices that may be used by an operator of the machine 10. For example, the operator control station 32 may include known devices, such as a seat assembly 34, a steering device 36, and one or more machine operation controllers 38. According to a specific example, a first machine operation controller 38 may be provided for controlling directional movement of the machine 10, while a second machine operation controller 38 may be provided for controlling operation of the implement 30. The operator control station 32 may include additional machine controllers, such as controllers for controlling the engine speed, gear ratio, rim pull, and the like.

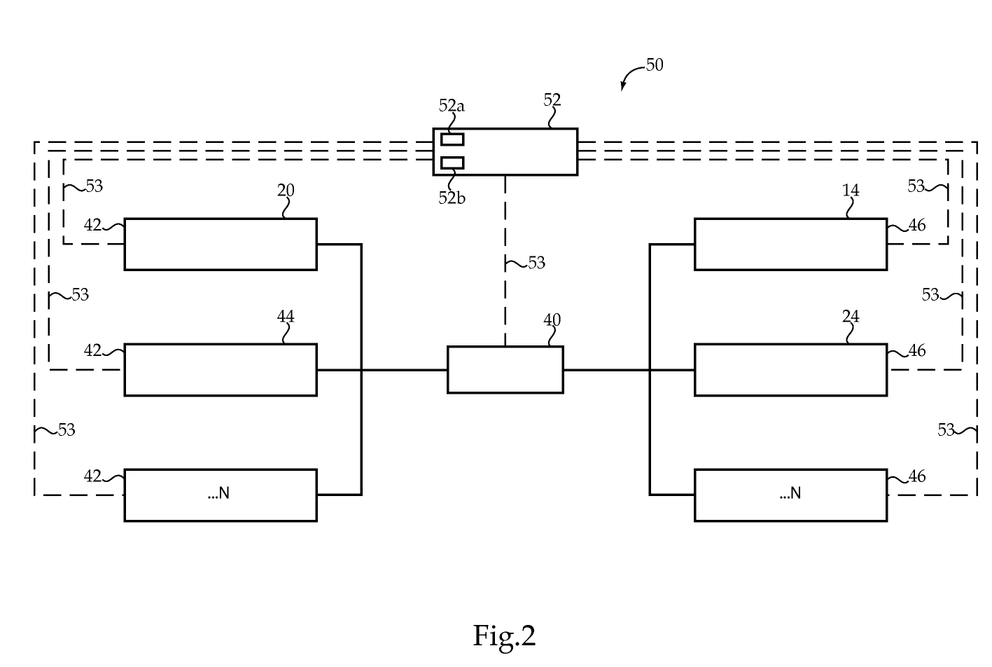

It should be appreciated that the engine 20 may be configured to combust fuel in one or more combustion chambers to reciprocate pistons within respective chambers. Each piston may be connected to a common crankshaft through a connecting rod, such that the reciprocating movement of the pistons turns the crankshaft. Referring now to FIG. 2, the linear movement of the pistons may be translated into rotational motion, which may be delivered to output 40, which may include a rotating shaft. In addition to the engine 20, the machine 10 may include a plurality of additional torque producing devices 42 or systems configured to rotate the output 40. For example, a secondary engine 44 and/or any other suitable power source may also be configured to generate, store, accumulate, and or distribute torque. The one or more additional devices, like the engine 20, may be operatively coupled to the output 40 such that they help rotate the output 40.

Referring still to FIG. 2, the machine 10 may also include one or more torque consuming devices 46. The torque consuming devices 46 may include any device or system of the machine 10 configured to transform an input, such as torque from output 40, into an output, such as movement of the ground engaging devices 16, the implement 30, and/or any other change in the state of the machine 10. For example, the torque consuming devices 46 may include the drive system 14 and the implement system 24 described above with reference to FIG. 1. In particular, the engine 20 may provide output torque used to operate pump 18 of the drive system 14 and pump 26 of the implement system 24. Additional and/or alternative torque consuming devices 46 that are drivingly coupled to the engine 20 are also applicable to the engine torque load control strategy provided herein.

A control system 50, such as an electronic control system, may include at least one onboard electronic controller 52 configured to control operation of the machine 10. Although a single electronic controller 52 is described, it should be appreciated that the control system 50 may include a plurality of electronic controllers. For example, additional electronic controllers may be provided for controlling different subsystems of the machine 10. As such, each electronic controller of the control system 50 may be configured to communicate laterally and/or in a hierarchical manner. Therefore, it should be appreciated that a variety of control systems, ranging from simple to complex, are contemplated for use with the present disclosure.

The electronic controller 52 may be of standard design and may include a processor 52a, such as, for example, a central processing unit, a memory 52b, or computer readable medium, and an input/output circuit that facilitates communication internal and external to the electronic controller 52. The processor 52a may control operation of the electronic controller 52 by executing operating instructions, such as, for example, computer readable program code stored in memory 52b, wherein operations may be initiated internally or externally to the electronic controller 52. A control scheme, an example of which is provided below, may be utilized that monitors outputs of systems or devices, such as, for example, sensors, actuators, or control units, via the input/output circuit to control inputs to various other systems or devices.

The memory 52b may comprise temporary storage areas, such as, for example, cache, virtual memory, or random access memory, or permanent storage areas, such as, for example, read-only memory, removable drives, network/internet storage, hard drives, flash memory, memory sticks, or any other known volatile or non-volatile data storage devices. Such devices may be located internally or externally to the electronic controller 52. One skilled in the art will appreciate that any computer based system or device utilizing similar components for controlling the components or subsystems of the machine 10, is suitable for use with the present disclosure.

As shown, the electronic controller 52 may be in communication with each of the torque producing devices 42, output 40, and torque consuming devices 46 via communication lines 53. For example, the electronic controller 52 may be in communication with the engine 20 to control a speed thereof, such as, for example, by issuing control commands, or control signals, via communication lines 53 to control fueling and/or air to the engine 20, which may be a turbocharged engine. The engine speed may be adjusted, at least in part, based on a position of one or more machine operation controllers 38. As should be appreciated, the electronic controller 52 may also receive input from various sensors or devices monitoring operating conditions of the engine 20. Such devices and means for controlling operation of the engine 20 are known and, thus, will not be discussed in greater detail herein.

The electronic controller 52 may also be in communication with the variable displacement pump 18 and the variable displacement motors 22. More specifically, for example, the electronic controller 52 may be in communication with the variable displacement pump 18 to adjust the swash plate angle thereof, resulting in the variable displacement described above. According to one embodiment, a pump displacement solenoid, such as a proportional solenoid, may be provided for varying the swash plate angle and controlling the direction of fluid flow. However, various means for adjusting displacement and fluid flow are known and may be incorporated into the present disclosure. Accordingly, the electronic controller 52 may issue pump displacement commands or signals and/or additional commands or signals, via wired or wireless communication lines 53, to the variable displacement pump 18 to effectively control the displacement and direction of fluid flow of the variable displacement pump 18. Similarly, the electronic controller 52 may be in communication with the variable displacement motors 22 to adjust angles of the swash plates of the motors 22. As stated above, devices and means for controlling displacement and fluid flow are generally known and, therefore, will not be discussed herein in greater detail.

The electronic controller 52 may also be in communication with additional torque consuming devices 46, including the implement system 24, to similarly monitor and control operation thereof. For example, the electronic controller 52 may be in communication with the implement pump 26, which may include a variable displacement or fixed displacement pump, to monitor and control operation of the implement system 24 in a known manner. As should be appreciated, the implement 30 may be controlled, at least in part, based on a position of one or more of the machine operation controllers 38.

The torque consuming devices 46, including the drive system 14 and implement system 24, may take torque from the output 40 as it is rotated by one or more torque producing devices 42, such as the engine 20, and, thus, may act as a torque load on the engine 20. The torque requirements of the torque consuming devices 46 may be relatively constant, or may vary over time depending on the operations being performed. As torque consuming devices 46 take or use torque from the output 40, they may have an effect on the engine 20. For example, when the torque required by the torque consuming devices 46 increases, the torque load on the output 40 increases. To increase the speed and, thus, power or work of the engine 20 to meet the required demands, the electronic controller 52 may adapt operation of the engine 20.

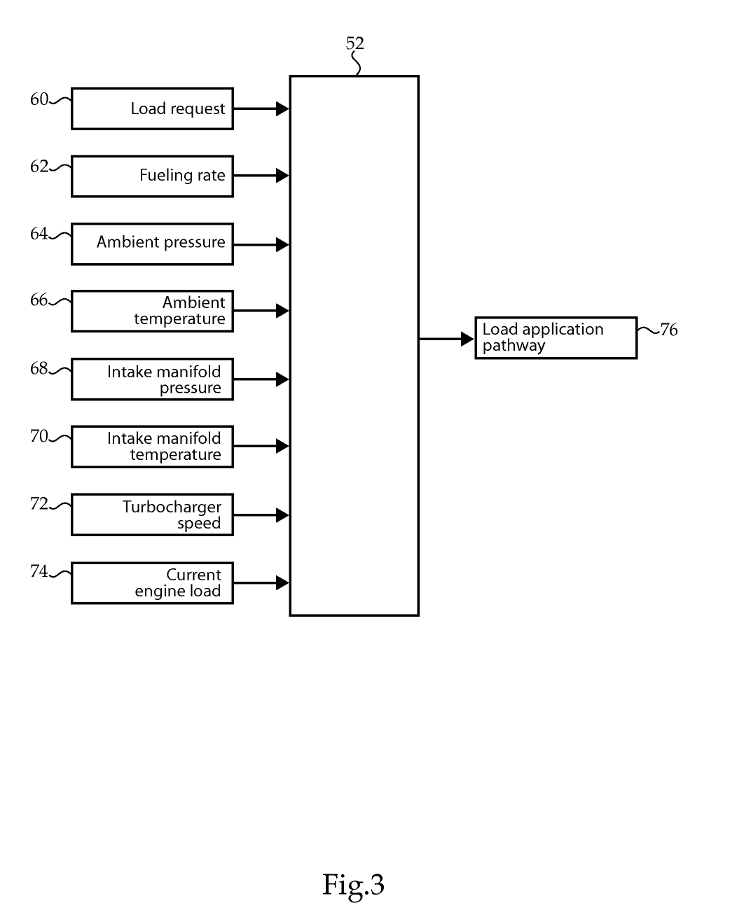

According to the present disclosure, the control system 50 may include a torque load control algorithm for controlling load application to the engine 20. Referring to FIG. 3, for example, the electronic controller 52 may receive a load request 60, in the form of a torque load signal, which may include individual or combined load requests, from the torque consuming devices 46. The electronic controller 52 may also receive a plurality of signal inputs indicative of a current operating state of the internal combustion engine 20. In particular, the electronic controller 52 may receive a fueling rate 62, an ambient pressure 64, an ambient temperature 66, an intake manifold pressure 68, an intake manifold temperature 70, a turbocharger speed 72, and a current engine load 74. These values, which may include additional or alternative values, may be determined or sensed using various sensors or devices in communication with the electronic controller 52 and may be used by the processor 52a to determine the current operating state of the engine 20. Based at least in part on the load request and the current operating state, which is determined using known means, the electronic controller 52 may be configured to determine a load application pathway 76 for transitioning the engine 20 from the current operating state to a requested operating state corresponding to the requested load.

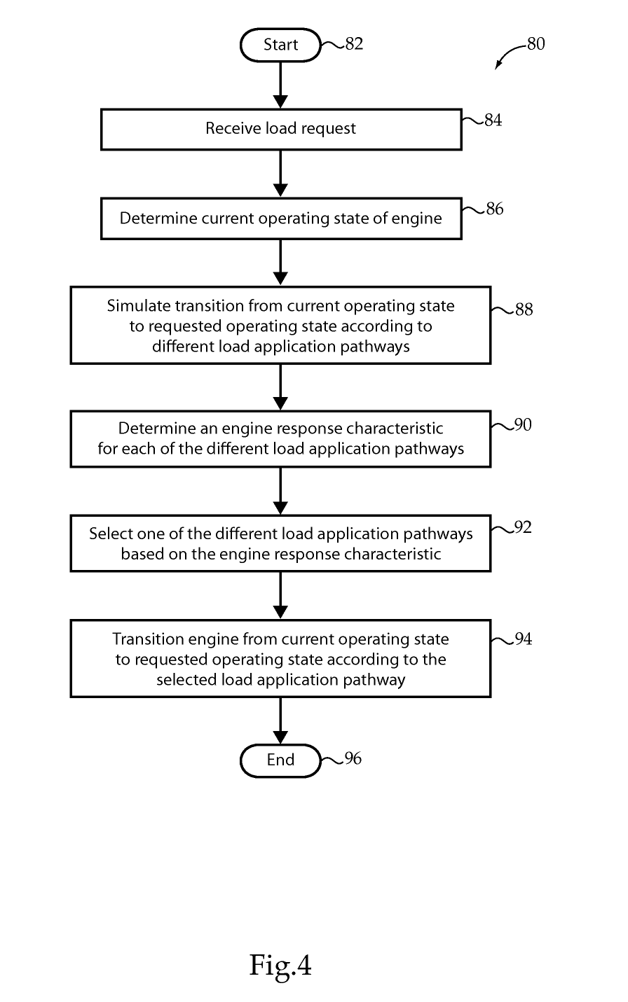

Turning to FIG. 4, there is shown a flow chart 80 representing an exemplary method for controlling engine torque load in the machine 10 and, more particularly, to a method for selecting the load application pathway 76 introduced above. The method may be implemented by the control system 50 of the machine 10 and, according to one example, the steps implementing the disclosed method may be in the form of computer readable program code stored in memory 52b and executed by the processor 52a of the electronic controller 52. The method may run continuously or may be initiated in response to a predetermined event. For example, the torque load control algorithm may be initiated in response to a load request or a change in load request.

The method begins at a START, Box 82. From Box 82, the method proceeds to Box 84, which includes the electronic controller 52 receiving the load request 60, such as in the form of a load request signal, which represents torque requirements for the torque consuming devices 46. The load request 60, which may represent individual or combined torque requirements for the torque consuming devices 46, may be based on inputs from the one or more machine operation controllers 38, which may reflect an operator request for power, and/or inputs from the torque consuming devices 46 or other machine components. From Box 84, the method proceeds to Box 86, which includes the electronic controller 52 receiving signals from one or more sensors or devices monitoring the engine 20 to determine the current operating state of the engine 20. For example, the electronic controller 52 may evaluate one or more of the fueling rate 62, ambient pressure 64, ambient temperature 66, intake manifold pressure 68, intake manifold temperature 70, turbocharger speed 72, and current engine load 74 to identify a current operating state of the engine 20. However, it should be appreciated that additional or alternative operational characteristics may be evaluated to arrive at a current operating state.

The electronic controller 52, at Box 88, may then simulate, or forward simulate, transition of the engine 20 from the current operating state, as determined at Box 86, to a requested operating state, corresponding to the load request of Box 84, according to a plurality of different load application pathways. Each of the different load application pathways, examples of which will be discussed below, may represent potential changes in engine state to arrive at the requested operating state and deliver the requested load. For example, each of the different load application pathways may include load rates and load limits for providing the requested load.

The simulations, performed onboard the machine 10 by the electronic controller 52, may include algorithms or equations for performing predictive modeling. For example, the electronic controller 52 may receive as inputs the current operating state and the requested operating state, as indicated by the load request 60. For each simulation, or forward simulation, the electronic controller 52 will follow one of the different load application pathways according to time steps to predict engine response to the load change according to the specific pathway. Specifically, each simulation will include a plurality of loops, with each loop representing the simulation of a combustion event according to a current engine condition and/or results from the previous loop and the desired engine state corresponding to the load application pathway.

During each of the simulations, the electronic controller 52 may determine one or more engine response characteristics, at Box 90. The engine response characteristics, examples of which are provided below, may represent predicted engine responses to the requested load change according to each of the load application pathways, as determined during the simulations. Based on these one or more engine response characteristics, the electronic controller 52 may select one of the different load application pathways for transitioning the engine 20 from the current operating state to the requested operating state (Box 92). At Box 94, the engine 20 may then be transitioned from the current operating state to the requested operating state according to the selected load application pathway. For example, the electronic controller 52 may generate engine control signals and or torque consuming device control signals corresponding to the selected load application pathway. The method then proceeds to an END, at Box 96.

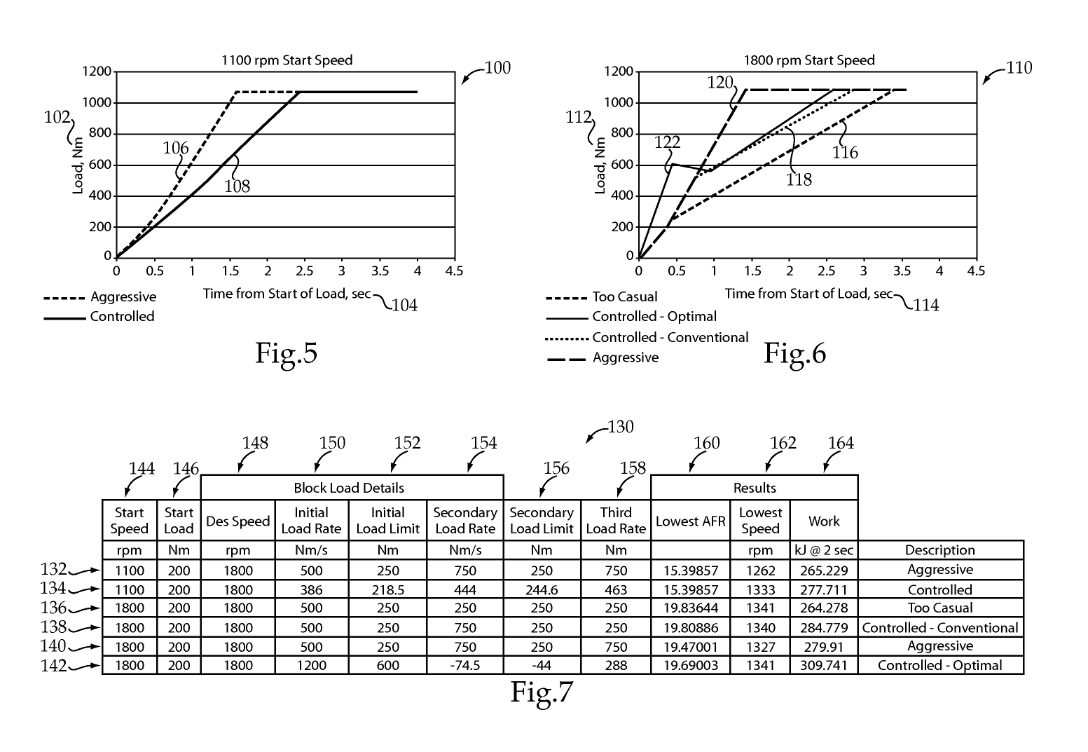

FIG. 5 illustrates a graph 100 of engine load 102 in Newton metres (Nm), shown on the vertical axis, versus time 104 in seconds, shown on the horizontal axis. Depicted on the graph 100 are first and second exemplary load application pathways, or load profiles, 106 and 108. Each of the load application pathways 106 and 108 represents one or more load rates and one or more load limits for transitioning the engine 20 from the current operating state to the requested operating state. According to the specific example, the load application pathways 106 and 108 represent two alternatives for transitioning the engine 20, which may be operating at an engine speed of 1100 revolutions per minute (RPMs), from a nominal load to a requested load of about 1050 Nm.

Turning now to FIG. 6, another graph 110 of engine load 112, shown on the vertical axis, versus time 114, shown on the horizontal axis, is shown. Depicted on the graph 110 are third load application pathway 116, fourth load application pathway 118, fifth load application pathway 120, and sixth load application pathway 122. These exemplary load application pathways 116-122 may represent alternatives for transitioning the engine 20, which may be operating at an initial engine speed of 1800 RPMs, from the current operating state to the requested operating state. In particular, each of the load application pathways 106, 108, and 116-122 may include a specific path for modifying operation of the engine 20 to meet the requested load. Engine responses to each of these different load application pathways 106, 108, and 116-122 may be predicted using the simulations, or forward simulations, described above and used to evaluate each of the different pathways 106, 108, and 116-122.

Preferably, each of the load application pathways 106, 108, and 116-122 includes a variable load application rate. Referring also to FIG. 7, a chart 130 is shown including the load application rate details and engine response characteristics for each of the load application pathways 106, 108, and 116-122 of FIGS. 5 and 6. In particular, row 132 corresponds to pathway 106, row 134 corresponds to pathway 108, row 136 corresponds to pathway 116, row 138 corresponds to pathway 118, row 140 corresponds to pathway 120, and row 142 corresponds to pathway 122. An engine start speed is shown in column 144 for each of the pathways 106, 108, and 116-122, as well as a nominal engine start load, as shown in column 146. The requested operating state may include a desired engine speed of 1800, as shown in column 148, for each of the pathways 106, 108, and 116-122.

According to the exemplary embodiment, each of the load application pathways 106, 108, and 116-122 may include three different load application segments. In particular, each of the pathways 106, 108, and 116-122 may include a first segment including a first load rate 150 and a first load limit 152, a second segment including a second load rate 154 and a second load segment 156, and a third segment including a third load rate 158 for transitioning to the requested load. For example, load application pathway 106, shown at row 132 in the table 130, includes a first segment during which the load is increased at 500 Nm per second until the load reaches 250 Nm. During a second segment, the engine load is increased at 750 Nm per second until the load reaches 250 Nm. Finally, during a third segment, the load is increased at 750 Nm per second until the requested load is reached. According to another example, load application pathway 120, shown in row 140 of the table 130, includes a first segment during which the load is increased at 500 Nm per second until the load reaches 250 Nm. During a second load segment, the load is increased at 750 Nm per second until the load reaches 250 Nm. During a third segment, the load is increased at 750 Nm per second until the requested load is reached. As should be appreciated, each segment intersection point may be treated as a new point of origin. For example, the secondary load limit is relative to the stopping point of the first segment and, thus, is essentially a delta load from the initial load limit. Although three segments are shown, it should be appreciated that any number of segments may be selected, depending on the desired shaping of the load profiles. Such determinations may, for example, be made using offline testing.

During each of the simulations, or forward simulations, one or more engine response characteristics is determined. For example, the electronic controller 52 may be configured to evaluate how the engine responds during the transitions to the requested operating state according to each of the different load application pathways 106, 108, and 116-122. As such, the load application pathways 106, 108, and 116-122 can be evaluated based on predetermined criteria to identify a selected or preferred load application pathway. For example, it may be desirable to determine a lowest air to fuel ratio 160, a lowest engine speed 162, and a work value 164 during each of the simulations, as is shown in the chart 130. Although specific examples are given, it should be appreciated that different applications may benefit from evaluations of different criteria.

For example, maximizing work produced by the engine 20 may be a primary objective. As such, the work value 164, representing the amount of work produced by the engine 20 at 2 seconds after the transition to the requested operating state begins may be evaluated. Of the exemplary load application pathways 106, 108, and 116-122, load application pathway 122, shown at row 142 of table 130, is shown as producing the most work at the specified time. However, it should be appreciated that additional criteria may also be considered. For example, if two of the load application pathways 106, 108, and 116-122 appear to produce similar work output, additional criteria, such as fuel consumption and/or emissions may also be considered. Evaluating the lowest air to fuel ratio 160 may also be desirable for aftertreatment management purposes. Further, it may also be desirable to consider the lowest engine speed 162, or engine droop, to reduce the risk of the engine speed falling below an undesirable value. An equation for selecting an optimal pathway may be one that weights the evaluated engine response characteristics as deemed appropriate, depending on the particular application.

### INDUSTRIAL APPLICABILITY

The present disclosure finds potential application in any machine that includes one or more torque producing devices, such as an engine, configured to produce torque for one or more torque consuming devices. Further, the present disclosure may be specifically applicable to control strategies for controlling engine torque load. Yet further, the disclosure may be applicable to control strategies for selecting a load application pathway for transitioning the engine from a current operating state to a requested operating state based on engine response characteristics predicted during onboard simulations

Referring generally to FIGS. 1-7, a machine 10 may include one or more torque producing systems 42, including an engine 20, such as a turbocharged engine, producing torque through an output 40 to one or more torque consuming devices 46, including a drive system 14 and an implement system 24. A control system 50, including at least one electronic controller 52, may be provided for controlling an engine torque load of the machine 10. In particular, the control system 50 may execute a torque load control algorithm for determining a load application pathway 76 for transitioning the engine 20 from a current operating state to a requested operating state.

In particular, the torque load control algorithm may execute in response to a load request, such as a load request indicated by movement of one or more machine operation controllers 38. In response to receiving the load request, the electronic controller 52 may determine a current operating state of the engine 20, such as, for example, by evaluating one or more of a fueling rate 62, an ambient pressure 64, an ambient temperature 66, an intake manifold pressure 68, an intake manifold temperature 70, a turbocharger speed 72, and a current engine load 74. The electronic controller 52 may then simulate transitions of the engine 20 from the current operating state to a requested operating state, which corresponds to the load request, according to a plurality of different load application pathways, such as, for example, pathways 106, 108, and 116-122. An engine response characteristic, such as one or more of characteristics 160-164, is determined for each of the load application pathways 106, 108, and 116-122, and one of the pathways is selected based on an evaluation of the engine response characteristics 160-164. The engine 20 is then transitioned from the current operating state to the requested operating state according to the selected load application pathway 106, 108, and 116-122.

The engine torque load control strategy provided herein uses a design of experiments approach to optimizing the engine transition from a current operating state to a requested operating state. In particular, the control strategy uses onboard, and on-the-fly, simulations to predict the engine response to different load pathways, or profiles, for delivering a requested load. The predicted engine responses to the various alternative load pathways are then evaluated to identify an optimum pathway for a given application. As such, the control strategy provided herein alleviates the need for lookup tables representing all potential load pathways and engine starting conditions, and provides a dynamic and robust means for optimally shaping engine load applications.

It should be understood that the above description is intended for illustrative purposes only, and is not intended to limit the scope of the present disclosure in any way. Thus, those skilled in the art will appreciate that other aspects of the disclosure can be obtained from a study of the drawings, the disclosure and the appended claims.

What is claimed is:

1. A machine, comprising:
an internal combustion engine;
at least one torque consuming device drivingly coupled with the internal combustion engine; and
an electronic controller in communication with the internal combustion engine and the torque consuming device, wherein the electronic controller is configured to:
receive a load request;
determine a current operating state of the internal combustion engine;
simulate transition of the internal combustion engine from the current operating state to a requested operating state according to a plurality of different load application pathways;
determining an engine response characteristic for each of the plurality of different load application pathways;
selecting one of the plurality of different load application pathways based on the engine response characteristic; and
transitioning the internal combustion engine from the current operating state to the requested operating state according to the selected one of the plurality of different load application pathways.

2. The machine of claim 1, wherein each of the plurality of different load application pathways includes a variable load application rate.

3. The machine of claim 2, wherein each of the plurality of different load application pathways includes at least three different load application rates.

4. The machine of claim 2, wherein the electronic controller is further configured to determine the current operating state based on at least one of a fueling rate, an ambient pressure, an ambient temperature, an intake manifold pressure, an intake manifold temperature, a turbocharger speed, and a current engine load.

5. The machine of claim 2, wherein the engine response characteristic is based on at least one of a work output, an air to fuel ratio, and a speed droop.

6. The machine of claim 5, wherein the electronic controller is further configured to select the one of the plurality of different load application pathways based on the work output.

7. The machine of claim 1, wherein a drive system and an implement system are drivingly coupled with the internal combustion engine.

8. A method of controlling engine torque load on an internal combustion engine of a machine, the machine including at least one torque consuming device drivingly coupled with the internal combustion engine, the method comprising:
generating a load request;
determining a current operating state of the internal combustion engine responsive to the generating step;
simulating transition of the internal combustion engine from the current operating state to a requested operating state according to a plurality of different load application pathways using an onboard electronic controller of the machine;
determining an engine response characteristic for each of the plurality of different load application pathways using the onboard electronic controller;
selecting one of the plurality of different load application pathways based on the engine response characteristic; and
transitioning the internal combustion engine from the current operating state to the requested operating state according to the selected one of the plurality of different load application pathways.

9. The method of claim 8, wherein the simulating step includes simulating transition of the internal combustion engine from the current operating state to the requested operating state according to a pathway having a variable load application rate.

10. The method of claim 9, wherein the simulating step further includes simulating transition of the internal combustion engine from the current operating state to the requested operating state according to a pathway having at least three different load application rates.

11. The method of claim 9, further including determining the current operating state based on at least one of a fueling rate, an ambient pressure, an ambient temperature, an intake manifold pressure, an intake manifold temperature, a turbocharger speed, and a current engine load.

12. The method of claim 9, further including selecting the one of the plurality of different load application pathways based on at least one of a work output, an air to fuel ratio, and a speed droop.

13. The method of claim 12, further including selecting the one of the plurality of different load application pathways based on the work output.

14. The method of claim 8, wherein the transitioning step includes distributing torque produced by the internal combustion engine among a drive system and an implement system.

15. A computer readable medium for use by an electronic controller for a machine, the machine including at least one torque consuming device drivingly coupled with an internal combustion engine, the computer readable medium having executable instructions for performing a method of controlling engine torque load, the method comprising:
receiving a load request signal;
receiving input signals from the internal combustion engine;
determining a current operating state of the internal combustion engine based on the input signals;
simulating transition of the internal combustion engine from the current operating state to a requested operating state according to a plurality of different load application pathways;
determining an engine response characteristic for each of the plurality of different load application pathways;
selecting one of the plurality of different load application pathways based on the engine response characteristic; and
generating at least one of an engine control signal and a torque consuming device control signal corresponding to the selected one of the plurality of different load application pathways.

16. The computer readable medium of claim 15, wherein each of the plurality of different load application pathways includes a variable load application rate.

17. The computer readable medium of claim 16, wherein each of the plurality of different load application pathways includes at least three different load application rates.

18. The computer readable medium of claim 15, wherein the method further includes receiving input signals from the internal combustion engine indicative of at least one of a fueling rate, an ambient pressure, an ambient temperature, an intake manifold pressure, an intake manifold temperature, a turbocharger speed, and a current engine load.

19. The computer readable medium of claim 15, wherein the method further includes selecting the one of the plurality of different load application pathways based on at least one of a work output, an air to fuel ratio, and a speed droop.

20. The computer readable medium of claim 19, wherein the method further includes selecting the one of the plurality of different load application pathways based on the work output.
